(19) United States
(12) Patent Application Publication
(10) Pub. No.: US 2017/0045463 A1
(43) Pub. Date: Feb. 16, 2017

(54) VOLUMETRIC SUBSTRATE SCANNER

(71) Applicant: RUDOLPH TECHNOLOGIES, INC., Wilmington, MA (US)

(72) Inventor: Holger Wenz, Orbis (DE)

(73) Assignee: Rudolph Technologies, Inc., Wilmington, MA (US)

(21) Appl. No.: 15/305,380

(22) PCT Filed: Apr. 21, 2015
(86) PCT No.: PCT/US2015/026801

§ 371 Date: Oct. 20, 2016

Related U.S. Application Data
(60) Provisional application No. 61/982,197, filed on Apr. 21, 2014.

(51) Int. Cl. G01N 21/95; G01N 21/47; G01B 11/24; G01N 21/88

(52) U.S. Cl. CPC G01N 21/9501; G01N 21/8806; G01N 21/47; G01B 11/24; G01N 2021/4735; G01N 2201/06113

(57) ABSTRACT

A system for scanning a substrate and specifically a volume of that substrate to identify anomalous structures or defects is herein described. Radiation is focused at locations within the volume of the substrate and measurements of scattered light are made. Scanning of the volume of a substrate may be fairly uniform or over selected regions, favoring those regions of the substrate that are to be involved with subsequent substrate processing steps.

### TECHNICAL FIELD OF THE INVENTION

The present invention relates generally to scanning of a volume of a semiconductor substrate for anomalies and/or defects. In particular, the present invention relates to the scanning of substrates such as semiconductor wafers for voids and defects that may negatively affect semiconductor devices formed thereon.

### BACKGROUND OF THE INVENTION

As semiconductor devices get smaller, they are more adversely affected by defects in the substrate on which they are formed. Problems arising from improper chemistry or temperature control during formation of substrates may generate problems that affect the electrical characteristics of a semiconductor device or may even cause the substrate to physically break. It is best to identify substrates that may have such problems as early in the manufacturing process as is possible to avoid costs associated with processing substrates that may have a low yield or which may simply become unusable.

By identifying problems, discrepancies, defects, or excursions in control processes at an early stage, one can also validate proposed production methods or to ensure that existing production methods are adhered to. It should be noted however, that even in lots or groups of substrates that are otherwise “good” it may be possible to have a number of substrates that are outliers in terms of bad characteristics. Accordingly, it is helpful to conduct inspection and review processes as broadly and as thoroughly as possible.

Some methods of reviewing substrates such as silicon wafers include copper plating and the subsequent analysis of crystalline defects in the surface of a wafer revealed by the plating process. It has been found that a bare silicon wafer can be plated with a thin coat of copper to identify areas or locations of a wafer having structural or chemical features that are not conducive to the formation of semiconductor device. This is a time consuming and costly process and is generally conducted on a sampling basis.

Another method of reviewing substrates such as silicon wafers involves carefully honing and etching a wafer surface before it is scribed and cleaved along a selected crystalline plane that is often identified by its appropriate Miller index. The cleaved surface is then assessed using IR scattering tomography. This process, while more detailed, is even more time consuming than copper plating. Further, in this process only the cleaved surface of the wafer is reviewed.

In general, substrates are reviewed for defects only at their surface due to costs and time requirements. Various tomographic techniques familiar to those in the medical imaging industry do capture scattering information that is used to characterize a 3D volume that is under test, often a biologic specimen or even a person. However, these techniques require complex sensor arrangements that can differentiate light of one or more wavelengths scattered from an object of interest from multiple incident and/or azimuthal angles. Such systems are too slow for use in a production environment and are frankly too costly.

Other inspection techniques are much simpler and faster than the foregoing. For example, darkfield imaging techniques are frequently used to identify discontinuities in the surface of an object such as a silicon wafer. This imaging technique may be carried out at a very high sensitivity (10's of nanometers), however at higher sensitivities the complexity and speed of such a system is increased and decreased, respectively. At the opposite end of the proverbial spectrum, some optical systems are arranged to inspect an entire surface of a substrate at one time. In these cases however, the increased speed of such a system is offset by the uncertainty in the size and shape of an identified discontinuity.

As a result there is a strong need in the market place for a scanning inspection system that is capable of quickly and reliably vetting not only the surface of a substrate, but also the interior volume of the substrate. Further, this system must be relatively simple to operate and provide a high throughput as compared to the cost to own and operate the system.

### SUMMARY

One embodiment of a volumetric substrate scanner that meets the needs of the marketplace includes an illuminator, focusing optics, collection optics, a detector, a stage and a controller that are constructed and arranged to scan substantially all, or in some instances only selected parts, of a substrate such as a silicon wafer to identify anomalies or defects in the interior of the substrate. One aspect of this embodiment may involve an illuminator that outputs radiation that has at least one wavelength in the range of approximately 800 nm to 2000 nm. Other suitable wavelengths may also be used.

Focusing optics assist in the scan of the substrate by directing radiation toward a substrate and selectively focusing it along an optical path that intersects the substrate within its volume. Light scattered from the focal position of the radiation is collected and directed to a detector by collection optics. In one embodiment the collection optics include a spatial filter that omits specularly reflected light. The detector measures and records a characteristic of the light scattered from the substrate. One such characteristic is the intensity of the scattered light. Another characteristic may be a spectrum of scattered light, though the detector will require some form of spectrograph to distinguish a spectrum of scattered light. A simple photo diode or the like may be used to measure the intensity of scattered light.

A controller coordinates the illuminator, focusing optics, detector and a stage to ensure that a substrate is scanned as desired. As a result of this coordination, the volume of a substrate and perhaps at least one surface of the substrate as well are scanned for anomalies or defects.

### BRIEF DESCRIPTION OF THE DRAWINGS

FIG. 1 illustrates a prior art laser scanning system that addresses only the surface of a substrate.

FIG. 2 is a schematic representation of a substrate in cross section.

FIGS. 3a-3c schematically illustrate an embodiment of the present invention in which a volume of a substrate is scanned.

FIG. 4 schematically represents a substrate having a “flat” alignment structure.

FIG. 5 schematically represents a substrate having a “notch” alignment structure.

FIGS. 6a-6c schematically illustrate various scanning arrangements according to some embodiments of the present invention.

FIG. 7 is a flowchart representing an exemplary implementation of the present invention.

FIG. 8a is a schematic view of a detector having two sensors.

FIG. 8b is a schematic view of a detector having regions of a 2D surface thereof mapped to scattering angles and azimuthal angles of scattered light returned from a substrate.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

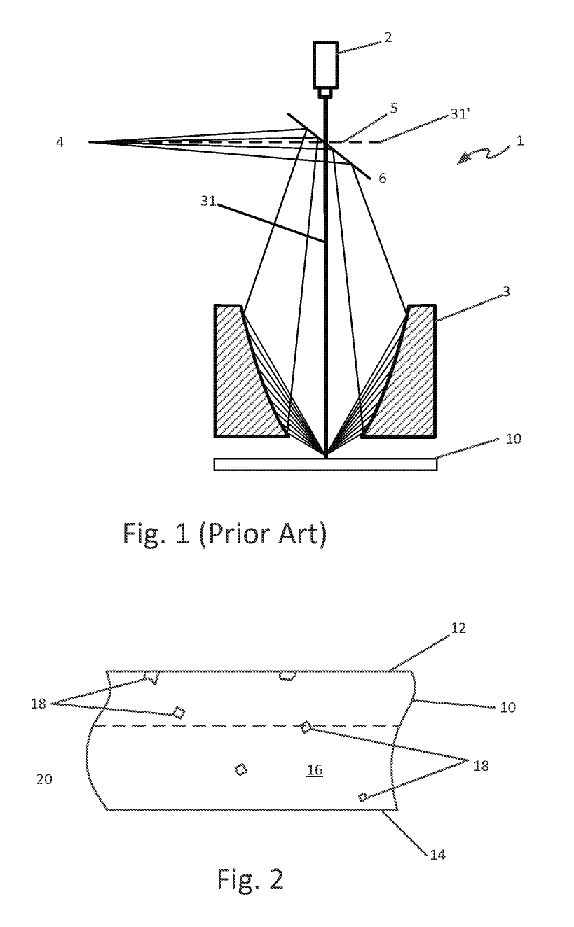

FIG. 1 illustrates a typical prior art laser scattering inspection system 1. This system includes a laser illuminator 2 that is focused on the surface of a substrate 10. Light scattered from the surface of the substrate is collected by collecting optic 3 that directs the collected light to detector 4. As this prior art system 1 is focused solely at the upper surface of the substrate 10, only discrepancies at or immediately adjacent the surface of the substrate 10, i.e. within the depth of field of the detector 4 are detectable.

FIG. 2 illustrates a cross section of a substrate 10 to which a scanner according to embodiments of the present invention may be addressed. In some instances the substrate 10 may be a silicon wafer used in the construction of semiconductor devices. Substrate 10 has a front side 12 and a back side 14. A volume 16 is defined by the two sides 12 and 14. Within the volume 16 are a number of defects 18. These defects 18 may be one of many different types and for the sake of brevity, only one type of defect, a void, will be discussed herein. Those skilled in the art will appreciate that other types of defects such as chips, cracks, crystalline defects, particles and the like may also be investigated. Some of the defects 18 are wholly within the volume 16 whereas some others are present at the surface of the substrate 10. A prior art devices such as a laser scattering inspection system 1 may only address the defects 18 that are present at or immediately adjacent the front side 12 of the substrate 10. While useful, this may not be adequate for all applications.

Those skilled in the art will appreciate that substrates 10 are often thinned as part of a manufacturing process. In particular, silicon wafers on which are formed semiconductor devices are often thinned as part of what is referred to as a back end packaging process. The grinding process is typically carried out using a chemical mechanical planarization process (CMP) that combines abrasive grinding with a chemical treatment that renders the material of the substrate 10 more friable, thereby speeding the grinding process. As the CMP process proceeds, multiple defects 18 are or may be exposed. In some circumstances, a defect 18 may give rise to a crack that travels through the volume 16 of the substrate 10, thereby breaking it either during the CMP process or during subsequent processing and packaging steps. Of particular import are defects 18 that exist at the back side 20 of a thinned substrate 10. Because defects 18 typically concentrate stresses in the material of the substrate 10, a thinned substrate may break at the location of the exposed defect 18. It is helpful to identify the existence and position of such defects 18 before a substrate 10 is thinned.

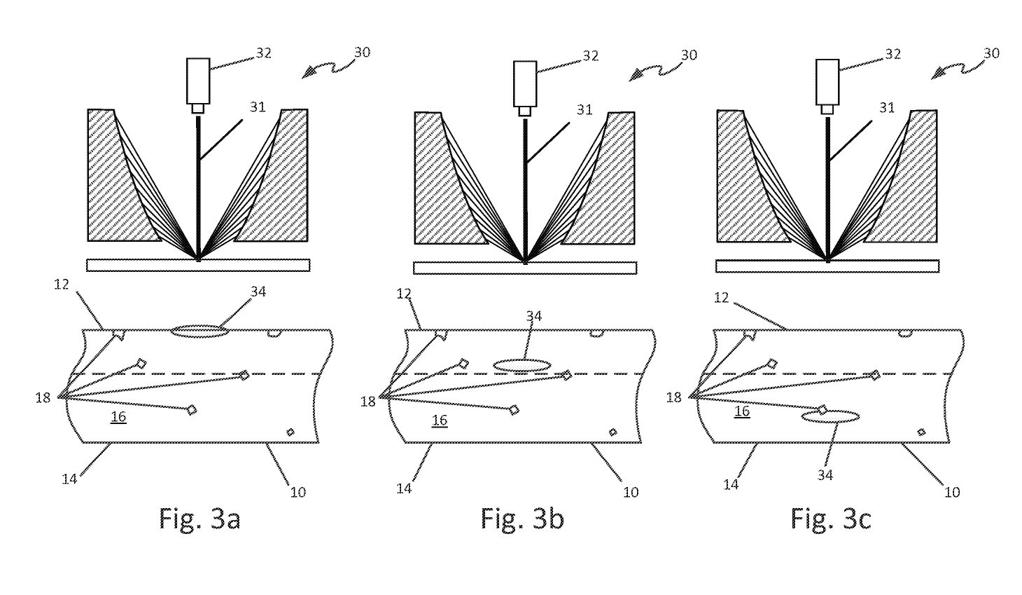

FIGS. 3a-3c illustrate a feature of the present invention that allows for scanning of the volume 16 of a substrate 10 for defects 18. Each of FIGS. 3a-3c has two portions, an upper portion which describes the basic opto-mechanical arrangement of a scanner 30 and a lower portion that schematically identifies a corresponding position of a scanning spot or focal position 34 positioned within the volume 16 of a substrate 10. The scanner 30 is similar in many respects to the prior art scanner 1 illustrated in FIG. 1, but is modified to accommodate the scanning of a volume 16, a process of which the prior art scanner 1 is incapable.

Scanner 30 includes an illumination source 32 that outputs light to which a substrate 10 is at least partially transparent. For a silicon wafer, the requisite wavelengths are in the near infrared ranges. Other substrates may require other wavelengths of light and these wavelengths will be known to those skilled in the art. In one embodiment is it has been found advantageous to use a super luminescent diode (SLED) that outputs a broad range of wavelengths of light as an illumination source 32. In other embodiments a diode laser of a suitable wavelength (e.g. IR wavelengths) or a halogen light source may be used. The range of wavelengths output by a typical source 32 of this type includes light with a wavelength of between about 700 nm and 1500 nm. Additional wavelengths of light in the visible ranges (about 400 nm to 700 nm) and longer infrared wavelengths (greater than 1500 nm) may also be present in the output of illuminator 32. Selection of a single wavelength or range of wavelengths may be obtained by operation the illuminator 32 to output only the selected wavelength or range of wavelengths, by using an illuminator 32 that only outputs the selected wavelength or range of wavelengths, or be introducing one or more wavelength specific filters (not shown) into the optical path 31 between the illuminator 32 and the substrate 10.

Illuminator 32 is provided with a set of focusing optics (not shown) that may focus the light output by illuminator 32 to a desired location along the optical path 31. As those skilled in the art will appreciate, focusing optics define a depth of focus for illuminating light that may be moved along the optical path 31 by adjusting the focusing optics. Focusing optics may include one or more refractive or reflective optical elements (not shown) that are adjustable to select both a desired depth of focus and a desired nominal focal plane position. Focusing optics may also provide a fixed depth of focus while retaining the ability to translate the focal plane along the optical axis.

In FIG. 3a light from the source 32 travels along optical path 31 and is focused by focusing optics (not shown) at the upper surface 12 of substrate 10. Light incident upon the substrate 10 is of a known range of wavelengths and has a known angle of incidence (in this instance substantially normal to the surface of the substrate 10) and azimuthal angles, i.e. light from source 32 forms a narrow cone whose point is located at focal position 34 seen in the lower portion of FIG. 3a.

Using the prior art inspection system 1 shown in FIG. 1 as an example of an opto-mechanical system it can be seen that light from a source 32 may pass through an aperture 5 in a mirror 6 on its way to the substrate 10. Light reflected directly back along the optical path 31 will pass back through the aperture in the mirror and be lost from the system. Light that is scattered by the substrate 10 and/or by a defect 18 will be incident upon the collection optic, which is in one embodiment a reflective elliptical surface of revolution that is symmetrical about the optical axis 31. The collection optic directs the scattered light to the mirror 6, which reflects the scattered light along a second optical path 31′ to a detector 4 such as that which forms a part of scanner 1. Note that in one embodiment of the present invention, the detector (not shown) of the scanner 30 measures intensity only and retains no angular (incidence or azimuthal) information about the scattered light other than that of the light from the source 32. In other embodiments the optical arrangement may be modified to retain some degree of angular information as part of a measurement recorded by the system 30. In yet other embodiments, the detector may also be a spectrometer of any useful type.

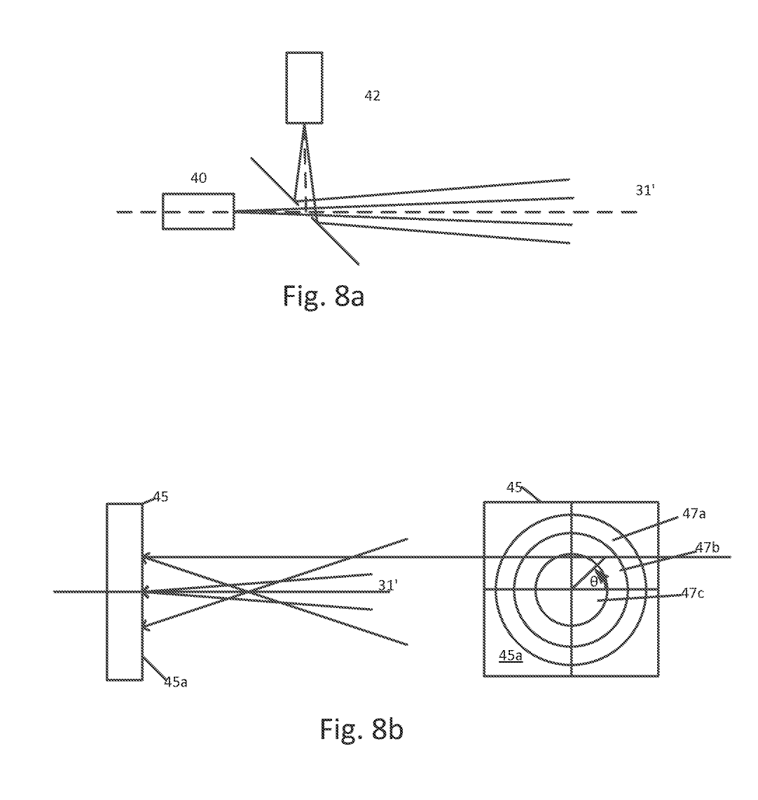

In FIG. 8a an embodiment of a detector in which two sensors 40 and 42, each of which detect an intensity of light, are shown. The sensors 40 and 42 are arranged about a splitting mirror 44 that separates light propagating along optical path 31′ based its angle of incidence relative to the optical path 31′. The splitting mirror 44 has an aperture 46 that acts as a spatial filter to split light propagating along the optical path 31′ into a first beam that is incident upon sensor 40 and a second beam that is incident upon sensor 42. The aperture 46 separates light scattered from the substrate 10 at different angles and provides additional data useful for characterizing the substrate 10 and its volume 16.

In the same vein, FIG. 8b illustrates an embodiment of a detector having a sensor 45 that has a 2D surface 45a upon which light scattered from the substrate 10 is incident. In this embodiment, the sensor 45 differentiates light scattered from the substrate 10 at different scattering angles and azimuthal angles by mapping these angles onto the 2D surface 45a of the sensor 45. The concentric regions 47a, 47b, and 47c each correspond to a set of respective scattering angles that are measured from the plane of the substrate 10. The azimuthal angle of the scattered light is measured about the optical axis 31 that is normal to the substrate 10. This azimuthal angle is mapped to the θ position on the sensor surface 45a. The sensor 45 may be a 2D sensor such as a CMOS or CCD sensor, however these have a fairly slow data rate. The sensor 45 may be a Cartesian or polar array of photo diodes or even a position sensitive device (PSD) of a useful type.

Other ways in which the scattering angle of light returned from the substrate 10 may be differentiated is to move the collecting optic 3 vertically with respect to the substrate whilst maintaining the focal spot in a desired position. This relative movement may change the range of scattering angles of scattered light that are directed to the detector. Further, one may form the collecting optic 3 with regions having different elliptical foci or major/minor axis lengths (not shown).

In FIG. 3b the focusing optics of the scanner 30 have moved the focal position 34 along the optical path 31 deeper into the volume 16 of the substrate 10. Similarly, FIG. 3c illustrates the focal position 34 at a still deeper position within the volume 16 of the substrate 10. Note that in some instances it may be desirable to provide a scanner 30 that has entirely fixed focusing optics. In this instance the substrate 10 will be moved vertically along the optical axis 31 to selectively position the focal position 34 within the volume 16 of the substrate 10.

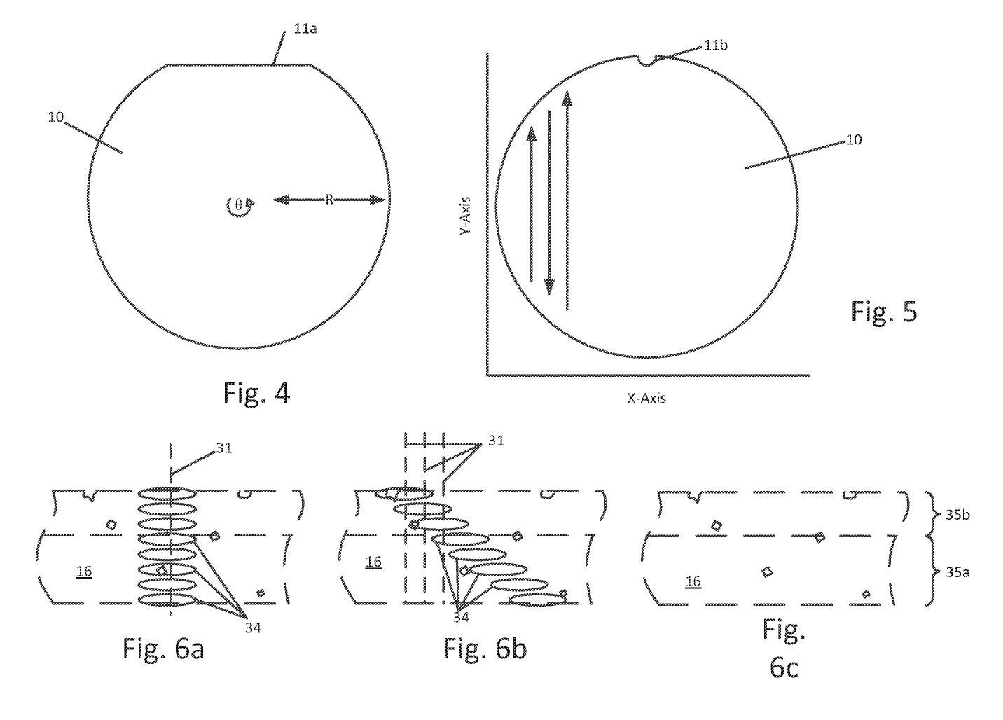

FIGS. 4 and 5 illustrate two scanning methods that may be used to move the scanner 30 laterally with respect to the substrate 10. In FIG. 4 a radial scanning arrangement is described. A substrate 10, in this case a silicon wafer having a “flat” alignment structure 11a is positioned upon a stage (not shown) that rotates the substrate 10 about an axis. In order to address the focal position 34 of the scanner 30 to substantially the entirety of the substrate 10, one need only move the substrate 10 and scanner 30 (specifically the focal position 34) relative to one another in a radial direction. This can be accomplished by moving the stage in a radial direction as it rotates or by moving the scanner 30 in a radial direction relative to the substrate 10. Note that the relative motion between the scanner 30 and the substrate 10 in the radial direction may be linear, curvilinear or discontinuous as needed.

In FIG. 5 the substrate 10 is a silicon wafer having a notch alignment feature 11b. In this embodiment the relative motion between the substrate 10 and the scanner 30 is in an XY plane. In some embodiments the focal position 34 will be moved along the surface of the substrate 10 in a boustrophedon path. In other instances the movement may describe a non-linear path intended address the focal position 34 of the scanner 30 to selected positions of the substrate 10 in the shortest amount of travel, e.g. along a path that is or approximates a spline path.

FIGS. 6a-6c illustrate various scanning arrangements of the scanner 30. Those skilled it the art will appreciate that additional arrangements of the focal position 34 are possible and these additional arrangements are to be covered by this disclosure and claims. In FIG. 6a the scanner 30 is positioned such that the optical axis 31 of the system intersects a selected R, θ or X, Y position of the substrate 10. The volume 16 of the substrate 10 along the optical axis is scanned by moving the focal position 34 of the scanner 30 to discrete vertical locations along the optical axis 31. In this embodiment, the optical axis 31 is parallel to the vertical Z axis though this need not be the case. Scanning a selected region or even substantially all of the volume 16 of the substrate 10 is accomplished by successively positioning the focal position 34 throughout the volume 16 or selected portions of the volume 16. The detector captures an intensity reading for each position of the focal position 34.

In FIG. 6b the focal position 34 of the scanner 30 is laterally offset for each position along the Z axis. In both FIGS. 6a and 6b, the vertical position is evenly distributed. Note that it is also possible to bias the vertical spacing such that a higher density scan is conducted at or near selected portions of the volume 16 of the substrate 10. In one embodiment, the substrate 10 can be vertically divided into a lower portion 35a, which will be removed through grinding and an upper portion 35b, which will remain after grinding. In this embodiment it is desirable to conduct a higher density scan in the upper portion 35b that will remain after grinding and to conduct a much lower density scan in the lower portion 35a. Alternatively, the lower portion 35b may be left substantially unscanned.

Those skilled in the art will appreciate that the focal position 34 of the scanner 30 defines a discrete space having dimensions measured along and normal to the optical path 31. The vertical dimension of the focal position 34 is also referred to as the depth of field or focal depth. The lateral extent of the focal position 34 is referred to as the spot size. These dimensions are a function of the index of refraction of the optical elements that make up the focusing optics, the medium through which light from the source 32 propagates (typically air) and the material of the substrate 10. Further, design choices may affect the magnitude of both the spot size and the depth of field. In one embodiment the spot size of the scanner 30 is approximately 20-30μ in diameter. In some embodiments it is useful to have a larger spot size of up to approximately 300μ in diameter. The depth of focus of the focal position 34 may be approximately 100-200μ in some embodiments. Regardless, one may achieve a scanning resolution with the scanner 30 of the present invention that is related to the dimensions of the selected focal position 34 and to more practical considerations such as the time available for scanning of a substrate. Also to be considered is the nature of the defect 18 that is the primary subject of the investigation of the substrate 10.

Scanning by scanner 30 is preferably conducted on a layer-by-layer basis, i.e. all measurements are conducted over the entire or selected regions of the substrate 10 at a given Z axis position whereafter the Z axis position is modified and all necessary measurements are again taken at the new Z axis position. As shown in FIG. 6a, each successive measurement at a new Z position may be at substantially the same R, θ or X, Y position as those that precede or follow a given measurement. Alternatively, the R, θ or X, Y positions for each successive new Z position may be offset as shown in FIG. 6b. By taking into account the vertical/horizontal/radial/angular spacing of the focal position 34 at each measurement position, one may scan the volume 16 of the substrate 10 at a desired resolution. As a general manner, increasing the spacing between the focal positions 34 at measurement results in a lower resolution, but faster scan of the substrate 10. Conversely, decreasing the spacing between the focal positions 34 at measurement results in a higher resolution, but somewhat slower scan of the substrate 10.

While the foregoing discussion of the positioning and spacing of the focal positions 34 at measurement has mostly assumed a layered scanning pattern in a rectilinear or radial arrangement, it is also possible to use other arrangements such as a spiral or helical scan pattern. For example, depending on the nature of the substrate 10 that is under test, one may adopt a 3D arrangement of the focal positions 34 during measurement that is best described by one of the Miller Indices most often used to describe the planes within a crystalline structure. Examples may include (100), (010), (001), (1̅00), (01̅0) (001̅), (101), (110), (011), (101̅), (11̅0) and (011̅). Other arrangements of the focal position 34 are also possible. For example, individual layers of focal position 34 measurement sites may be slightly interlocked, i.e. the focal positions 34 of the respective layers may overlap or even intersect to some extent. The vertical or horizontal pitch between each focal position 34 in a scanning arrangement may be uniform or variable.

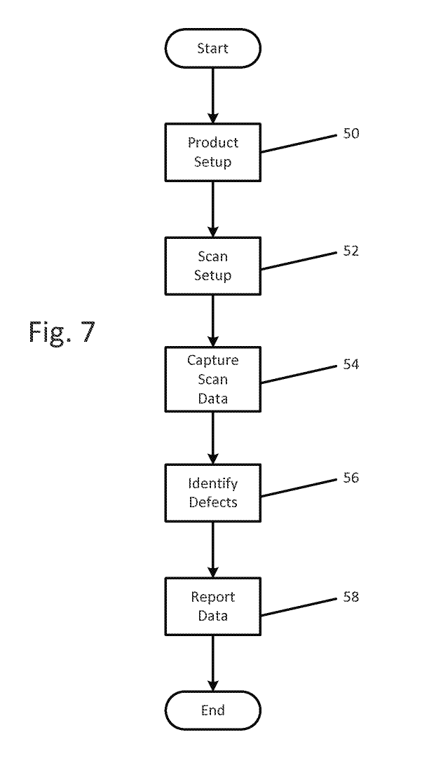

FIG. 7 illustrates schematically one manner in which the present invention is carried out. In the embodiment shown in the figure, the process starts with a product setup (step 50) in which basic information concerning a substrate 10 is provided to a controller (not shown) that is communicatively coupled to the scanner 30 and to a support such as a top plate of a stage (not shown) on which the substrate 10 rests. The controller is typically a computer of a suitable type and generally includes the necessary computing means (CPU, etc.), memory, and input/output necessary to control and coordinate the operation of a scanner 30 and the support (automation) necessary to move a substrate 10 and a scanner 30 relative to one another during operation.

Information input to the controller regarding the substrate 10 may include the basic geometry of the substrate including material, diameter, thickness, and orientation. The presence and geometry of alignment structures such as a flat 11a or a notch 11b may also be related. The product setup step 50 ensures that the scanner 30 and automation such as necessary handlers (not shown) and stages (not shown) are prepared to inspect substrates 10 in an efficient manner. Note that the product setup step 50 is part of a step called recipe creation that may also include the next, scan set up step 52.

The scan setup step 52 at least partially uses information obtained during the product setup step 50 to conduct the operations of the scanner 30 in a manner that provides useful results. Additional information may be input or generated at scan setup step 52 to ensure acceptable performance. Among the additional data that may be input and/or generated at the scan setup step 52 are defect characteristics such as geometry, product characteristics including information on subsequent process steps such as back grinding and information relating to time/throughput or data processing/communication constraints that may affect whether the scan merely samples a substrate 10 or inspects substantially all of the substrate 10. In addition, models that identify measured scattered light as being representative of a defect or not are generated and/or modified during the scan setup step 52. In particular, models may have to be updated to account for refraction that takes place within the body of the substrate 10, particularly where a substrate 10 is comprised of one or more layers of discrete materials. Note that substrates 10 may include, but are not limited to substrates such as silicon wafers, thermal oxide wafers, SOI (silicon on insulator) wafers, Ge wafers, GaAs wafers, InGaAs wafers, InAs wafers, 3˜5 group wafers, 2˜6 group wafer, epitaxial wafers, sapphire wafers, SiC wafers, ZnO wafers, MgO wafers, SrTiO3 wafers, single crystal wafers, quartz wafers, glass wafers, ceramic wafers and the like. In addition, in step 52 the scan pattern at which the scanner 30's focal position 34 will be positioned is also selected as described above.

In some embodiments steps 50 and 52 may be combined into a single step. For example, where a given substrate 10 is substantially similar to previously inspected substrates, previously generated product and scan setup data and steps may be used with the new substrates 10. In the same vein, it may be desirable to update or modify scan setups (step 52) from time to time, even where an existing product setup (step 50) may be used unchanged. This may be due to slight modifications in the substrates 10 themselves or due to a desire to refine and make more effective a model used to identify defects. Such models may in these cases be remade wholly or simply modified to account for new information or slight modifications in the substrates 10.

It is also to be understood that steps 50 and 52 may at times be referred to as recipe creation. A recipe is the set of all instructions and that is needed to successfully inspect, measure, or process a substrate 10. A complete recipe may be the result of the product and scan setup steps 50 and 52. However recipes may be simple or complex and may require additional information or order additional steps or analysis that are not explicitly part of steps 50 and 52 of the present invention as described herein.

Based at least in part on the product setup (step 50), during the capture scan data step 54, the substrate 10 and/or the scanner 30 are moved relative to one another so that the scanner 30 directs illumination onto the substrate 10 and data concerning how the substrate 30 scatters light at the selected focal positions 34 is measured. As described above, each measurement is at a discrete position in the 3D space (Cartesian or radial coordinate systems) defined by and including the exterior surfaces of the substrate 10. At a minimum, during step 54 the intensity of scattered light at each of the selected positions is measured and recorded together with the position of the focal position 34 when the measurement is taken.

Once measurements have been made, the collected data is used to identify defects (step 56), if any exist. In one embodiment, aspects of a model are compared with the measured scattered light and a binary determination of whether a defect is present is made. In another embodiment, aspects of a model are compared with the measured scattered light and characteristics of the substrate 10 at the focal position are determined. Depending on the nature of the determined characteristics, one may be able to determine the presence of a defect and discern some additional information such as, for example, the size or structure of the defect. In one example, it may be possible to discern whether a defect is a void in the substrate 10 or a crack in the surface of the substrate 10. Further, depending on the density of the scan, it may be possible to delineate the extent of a single defect in the substrate 10. It may also be possible to determine a density and spatial location or pattern of defects within the volume of the substrate 10.

In step 58 the information determined in step 56 is reported to at least one of a human user of the scanner 30 or to another computer or database (not shown). The reporting of data may be visual and or auditory such as by way of a video screen, paper, or by audible and/or visual alarms present on a screen or on a light tower (not shown) visible to a human user. The reportage of data may take place locally in the same location of the scanner 30 or may be conducted via wired or wireless network to a location remote from the scanner 30.

While it is often the case that steps 56 and 58 are carried out by or with the controller (not shown) that is coupled to the scanner 30, it is to be understood that the analysis and reportage of data embodied in these steps may take place remote from the scanner 30. In this embodiment data from the scanner 30 may be communicated to a secondary controller via a suitable network. This second controller, provided with suitable input/output capabilities as well as analysis and memory capabilities, may carry out steps 56 and 58 remotely. Further, it is possible to utilize a secondary controller to carry out steps 56 and 58 for a plurality of scanners 30.

### CONCLUSION

While various examples were provided above, the present invention is not limited to the specifics of the examples. Although specific embodiments of the present invention have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A volumetric substrate scanner, comprising:
an illuminator outputting radiation having at least one wavelength in the range of approximately 800 nm to 2000 nm;
focusing optics that receive the radiation from the illuminator and direct it toward a substrate where the radiation is selectively focused along an optical path intersecting the substrate within the volume of the substrate at a selected focal position;
collection optics that collect light scattered from the substrate and direct it to a detector the collection optics including a filter to omit specularly reflected light returned from the substrate, wherein the detector receives scattered light from the substrate and generates a signal that corresponds to a characteristic of the scattered light;
a stage for moving the substrate relative to the focal position of the radiation along a path; and,
a controller coupled to the illuminator, focusing optics, detector and stage that records the signal output by the detector and a position of the focal position of the radiation within the volume of the substrate based on a selected setting of the focusing optics and a position of the stage.

2. The volumetric substrate scanner of claim 1 wherein the collection optics further comprises an elliptical collector and a turning mirror, the turning mirror having an aperture to pass radiation from the illuminator to the substrate that is positioned such that specularly reflected light returned from the substrate passes through the aperture without being reflected by the turning mirror and where scattered light returned from the elliptical collect is directed to the detector.

3. The volumetric substrate scanner of claim 1 further comprising a detector that is a photo-diode sensitive to at least one wavelength in the range of 800 nm to 2000 nm.

4. The volumetric substrate scanner of claim 1 further comprising a stage that rotates the substrate about a vertical axis such that the path of the focal position of the radiation is curvilinear.

5. The volumetric substrate scanner of claim 1 further comprising a stage that moves the substrate linearly in a plane normal to the optical axis of the focusing optics.

6. The volumetric substrate scanner of claim 5 wherein the path of the focal position of the radiation is selected from a group of consisting of linear, boustrophedon and curvilinear.

7. The volumetric substrate scanner of claim 1 wherein the controller is adapted to compare the signal output by the detector to a model to identify the presence of a defect.

8. The volumetric substrate scanner of claim 1 wherein the controller is adapted to compare the signal output by the detector to a model to identify a characteristic of the substrate.

9. The volumetric substrate scanner of claim 1 wherein the controller is adapted to report data to a secondary controller.

10. A method of scanning a volume within a substrate comprising:
focusing radiation to which the substrate is at least partially transparent to a selected vertical position along an optical axis that is normal to the substrate;
moving the substrate relative to the focused radiation in a plane normal to the optical axis;
measuring periodically scattered light returned from the substrate and recording the position at which the radiation is focused within the volume of the substrate;
focusing the radiation at at least one different selected vertical position along the optical axis and repeating the measuring step at this different selected vertical position; and,
comparing the measured scattered light to a model to identify a defect, if any, in the volume within a substrate.

11. The method of scanning a volume within a substrate of claim 10 comprising:
reporting a presence and a location of a defect where one is identified within the volume of the substrate.

12. The method of scanning a volume within a substrate of claim 10 comprising:
measuring the scattered light in a volumetric pattern described by a Miller Index selected from a group consisting of (100), (010), (001), (1̅00), (01̅0) (001̅), (101), (110), (011), (101̅), (11̅0) and (011̅).

13. The method of scanning a volume within a substrate of claim 10 comprising:
providing a superluminescent light emitting diode; and
activating the superluminescent light emitting diode to provide the radiation that is focused onto the substrate.

14. The method of scanning a volume within a substrate of claim 10 the at least one different selected vertical position comprises a plurality of substantially evenly spaced positions along the optical axis.

15. The method of scanning a volume within a substrate of claim 10 wherein the at least one different selected vertical position comprises a plurality of positions wherein a majority of the plurality of positions are located between an upper surface of the substrate and a selected back grind location along the optical axis.

16. The method of scanning a volume within a substrate of claim 10 wherein the at least one different selected vertical position comprises a plurality of positions wherein a majority of the plurality of positions are located between an upper surface of the substrate and a selected back grind location along the optical axis.

17. The method of scanning a volume within a substrate of claim 10 wherein moving the substrate relative to the focused radiation involves defining a path selected from a group consisting of a helical path, a spiral path, an arcuate path, a curvilinear path, a boustrophedon path and a spline path.

18. The method of scanning a volume within a substrate of claim 17 wherein the selected path intersects a selected region of the substrate.

19. The method of scanning a volume within a substrate of claim 18 wherein the selected region of the substrate will have a discrete structure formed on or attached thereto in a subsequent processing step.
